(19) United States
(12) Patent Application Publication
(10) Pub. No.: US 2012/0221413 A1
(43) Pub. Date: Aug. 30, 2012

(54) INTELLIGENT PRESENTATION OF ADVERTISING WITH NAVIGATION

(75) Inventors: William P. Alberth, Prairie Grove, IL (US); Patricia A. Robb, Prairie Grove, IL (US)

(73) Assignee: MOTOROLA MOBILITY, INC., Libertyville, IL (US)

(21) Appl. No.: 13/034,827

(22) Filed: Feb. 25, 2011

(51) Int. Cl. G06Q 30/00

(52) U.S. Cl. 705/14.58

(57) ABSTRACT

A wireless communication device (200) and method (300). The wireless communication device (200) can include: a housing (210) including a display (240); a controller (220) coupled to the housing, the controller (220) configured to control the operations of a wireless communication device; and an intelligent advertising module (290) configured to: run a navigation application including an inputted destination; provide advertising content on a display (240), based on a simulated route to the destination; and filter the advertising content based on highlighting business establishments in proximity to a same side of a street as the wireless communication device will travel on. Advantageously, previewing a simulated route and previewing a listing of advertising content including business establishments, prior to or while traveling along a route, can help a user in planning time effective routes and cost efficient and effective shopping during commutes and trips.

### BACKGROUND

1. Field

The present disclosure relates to a method and device for intelligent presentation of advertizing with navigation.

2. Introduction

Users enjoy smart devices. Retrieving information wirelessly from a trusted source has become common place. Disadvantageously, often while viewing internet content unwanted and irrelevant advertizing is embedded or streamed over such content.

There is a need for a method and device for intelligent presentation of advertizing in connection with navigation that is focused and relevant to the interests of a user.

There is a further need to provide a personalized experience for intelligent presentation of advertizing in connection with navigation.

There is yet a further need to provide intelligent presentation of advertizing in connection with navigation that is user friendly and can use many components already found in many wireless communication devices.

Thus, a method and device that addresses these problems would be considered an improvement in the art.

### BRIEF DESCRIPTION OF THE DRAWINGS

In order to describe the manner in which the above-recited and other advantages and features of the disclosure can be obtained, a more particular description of the disclosure briefly described above will be rendered by reference to specific embodiments thereof which are illustrated in the appended drawings. Understanding that these drawings depict only typical embodiments of the disclosure and are not therefore to be considered to be limiting of its scope, the disclosure will be described and explained with additional specificity and detail through the use of the accompanying drawings in which:

FIG. 1 is an exemplary block diagram of a communication system according to one embodiment.

FIG. 2 is an exemplary block diagram of a wireless communication device according to one embodiment.

FIG. 3 is an exemplary block diagram of an intelligent presentation of advertizing with navigation method according to one embodiment.

FIG. 4 illustrates a wireless communication device connected to a docking module in a vehicular application, according to one embodiment.

### DETAILED DESCRIPTION

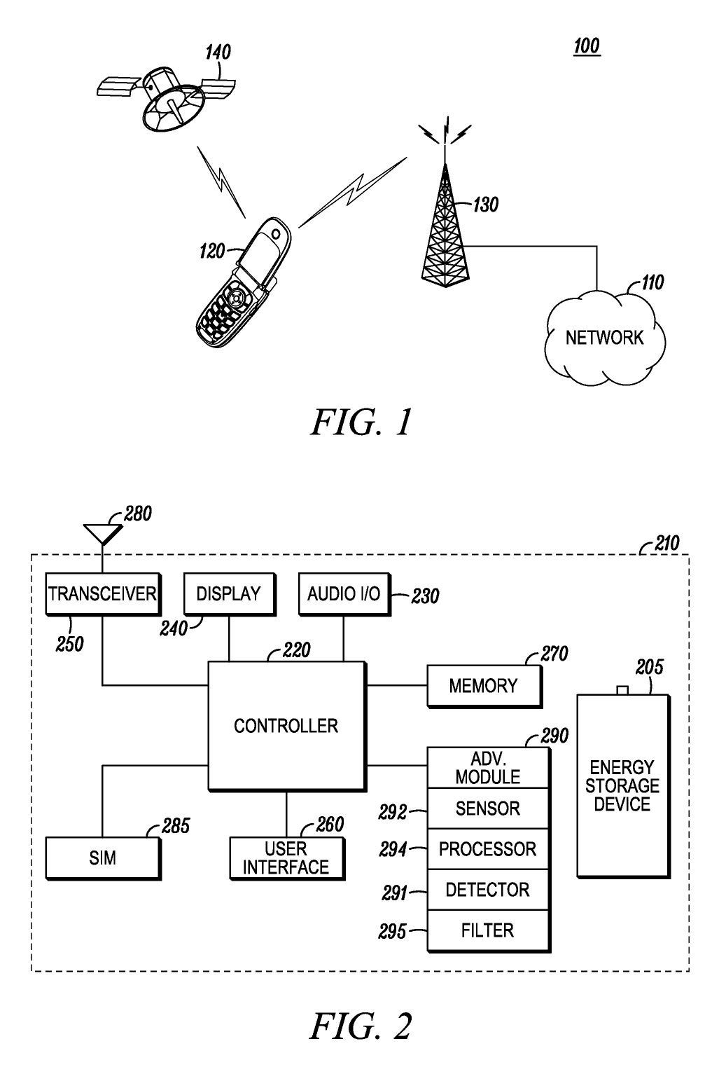

FIG. 1 is an exemplary block diagram of a system 100 according to one embodiment. The system 100 can include a network 110, a terminal 120, and a base station 130. The terminal 120 may be a wireless communication device, such as a wireless telephone, a cellular telephone, a personal digital assistant, a pager, a personal computer, a wireless pad, a selective call receiver, or any other device that is capable of sending and receiving communication signals on a network including a wireless network. The network 110 may include any type of network that is capable of sending and receiving signals, such as wireless signals. For example, the network 110 may include a wireless telecommunications network, a cellular telephone network, a Time Division Multiple Access (TDMA) network, a Code Division Multiple Access (CDMA) network, Global System for Mobile Communications (GSM), a Third Generation (3G) network, a Fourth Generation (4G) network, a satellite communications network, and other like communications systems. More generally, network 110 may include a Wide Area Network (WAN), a Local Area Network (LAN) and/or a Personal Area Network (PAN). Furthermore, the network 110 may include more than one network and may include a plurality of different types of networks. Thus, the network 110 may include a plurality of data networks, a plurality of telecommunications networks, a combination of data and telecommunications networks and other like communication systems capable of sending and receiving communication signals. In operation, the terminal 120 can communicate with the network 110 and with other devices on the network 110 by sending and receiving wireless signals via the base station 130, which may also comprise local area, and/or personal area access points. The terminal 120 is shown being in communication with a global positioning system (GPS) 140 satellite, global navigation satellite system (GNSS) or the like, for position sensing and determination.

FIG. 2 is an exemplary block diagram of a wireless communication device 200 configured with an energy storage device or module 205, such as in the terminal 120, or in a wireless communication device, for example. The wireless communication device 200 can include a housing 210, a controller 220 coupled to the housing 210, audio input and output circuitry 230 coupled to the housing 210, a display 240 coupled to the housing 210, a transceiver 250 coupled to the housing 210, a user interface 260 coupled to the housing 210, a memory 270 coupled to the housing 210, an antenna 280 coupled to the housing 210 and the transceiver 250, and a removable subscriber module 285 coupled to the controller 220.

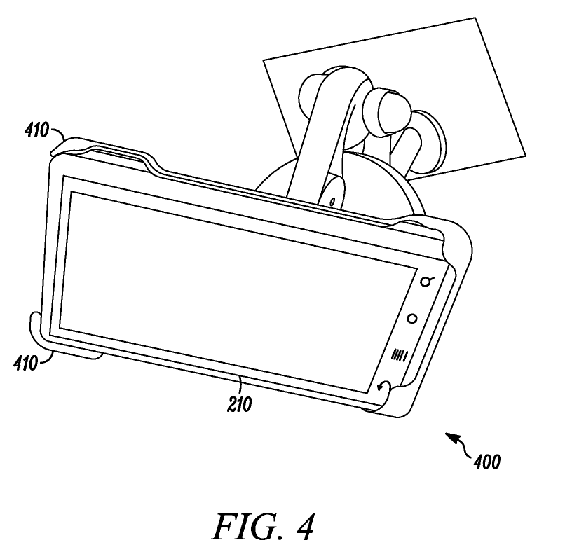

As shown in FIG. 2, the wireless communication device 200 further includes an intelligent advertizing module 290 configured to: run a navigation application in synchronous communication with an application server; detect a direction in which a wireless communication device is traveling along a route; sense a location of a wireless communication device along the route; provide advertising content on the display, based on the detected direction of travel and sensed location of the wireless communication device in proximity to the route; and filterer the advertising content based on the detected direction of travel, by preferentially highlighting business establishments on a same side of a street as the wireless communication device is traveling. Thus, the advertizing module 290 can include a detector module 291, a sensor module 292, a processor 294 and filter module 295, as detailed below. The wireless communication device 200 can be configured to be easily coupled to a docking module configured to receive a portion of the housing 210, as shown in FIG. 4.

In one embodiment, the advertizing module 290 includes the detector 291 and sensor 292 capable of being in communication with GPS, GNSS, cellular tower, and alike, and a processor module 294, coupled to the controller 220. In more detail, the module 290 can reside within the controller 220, can reside within the memory 270, can be an autonomous module, can be software, can be hardware, or can be in any other format useful for a module on a wireless communication device 200.

The display 240 can be a liquid crystal display (LCD), a light emitting diode (LED) display, a touch screen display, a plasma display, or any other means for displaying information. The transceiver 250 may include a transmitter and/or a receiver. The audio input and output circuitry 230 can include a microphone, a speaker, a transducer, or any other audio input and output circuitry. The user interface 260 can include a keypad, buttons, a touch pad, a joystick, an additional display, or any other device useful for providing an interface between a user and an electronic device. The memory 270 may include a random access memory, a read only memory, an optical memory or any other memory that can be coupled to a wireless communication device.

In more detail, the wireless communication device 200 shown in FIG. 2, can include: a housing 210; a controller 220 coupled to the housing 210, the controller 220 configured to control the operations of the wireless communication device, and to provide ancillary computing operations which may be unrelated to wireless communications such as audio or video processing, application processing, etc.

Advantageously, the intelligent advertizing module 290 can automatically and dynamically manage, for example, user settings for specific desired user interface experiences, as detailed herein. It is configured to help present intelligent, timely, relevant and useful advertizing content in connection with navigation and/or route planning, as provided in more detail herein.

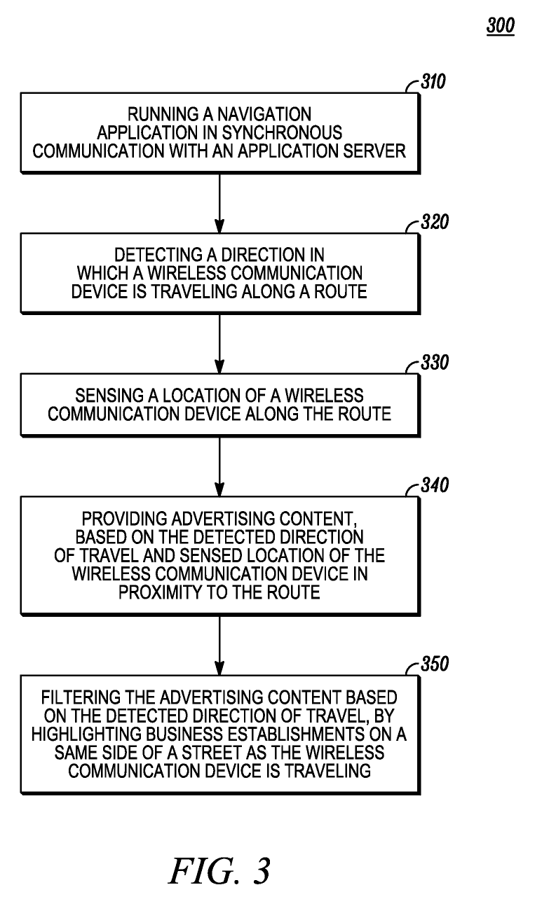

A block diagram of a wireless communication method 300 is shown in FIG. 3. In its simplest form, the method 300 can include: running 310 a navigation application in synchronous communication with an application server; detecting 320 a direction in which a wireless communication device is traveling along a route; sensing 330 a location of a wireless communication device along the route; providing 340 advertising content, based on the detected direction of travel and sensed location of the wireless communication device in proximity to the route; and filtering 350 the advertising content based on the detected direction of travel, by highlighting business establishments on a same side of a street as the wireless communication device is traveling.

Advantageously, the method 300 allows a service to highlight ads for establishments on the same side of the street as he or she is traveling. For example, when driving in rush hour, a user can try to avoid left hand turns into shopping centers because it may be difficult to in or get out, or otherwise be too time consuming to make a left turn, in the USA. As should be understood, in a use case in Great Brittan, a user would want to highlight ads for establishments on the left side of the street as he or she is traveling. Advantageously, this provides for more intelligent travel and commuting and an improved user experience.

In a preferred embodiment, a preview feature is provided to allow a user to preview a route and provide or present a listing of the advertizing content prior to or while traveling along the route. Advantageously, a user can strategically plan where to stop to eat, make a purchase and the like, prior to starting a commute or during a commute, which can save time and be more cost effective by pre-planning a route and going to an establishment having a sale.

In one embodiment, the advertising content is strategically queued and displayed based on the detected direction of travel along the route, which can provide timely advertising and marketing near an establishment or point of sale.

In a preferred embodiment, the advertising content can be queued, based on the detected direction of travel and sensed location of the wireless communication device, by providing early alerts prior to reaching a maneuver point in a route. Beneficially, presenting an early alert can reduce cognitive overload on the driver. Advantageously, this feature can provide a lower frequency of ad presentations to a user, prior to and during the time of a difficult or complicated maneuver.

In a preferred embodiment, the advertising content can be based on at least one of fees paid by a user, a predetermined distance in proximity to the route, recommendations, and interests of a user. In one case, a user may pay a higher fee to allow the user to opt out of receiving a lot of ads. And in another case, a user may pay a lower fee and receive more ads, for example.

In a preferred use case, the advertising content can be based on information mined from a social network. For example, if a user's friends have a certain interest, maybe the user does also. If a user expresses a like or dislike on Facebook, Twitter, a Blog or the like, for example, that information can be utilized for improved targeting of more focused and relevant ads.

The method 300 can include displaying navigation directions and advertising content concurrently on a display of a wireless communication device, to provide timely, useful and logical information for a user.

In one embodiment, the advertising content can be presented based on whether a recommendation is found for a business establishment or not. Thus, recommended ads can be presented, and if none are found, standard ads from a catalog can be queued or cycled for a certain route.

In more detail, if a recommendation is found, a first page can be displayed listing certain recommended advertising content, and if a recommendation is not found, a second page can be displayed listing certain standard advertising content.

In one case, the provided advertizing content can include at least one of being displayed via streaming, locally cached then displayed, and being presented and displayed at a predetermined periodic rate with the ad timing out after, for example, 3 seconds. As should be understood, other convenient ways are contemplated.

In one use case, a user can select the provided advertizing content 340 and display a location of a business establishment as a way point in proximity to the route. Thus, if the user selects an ad, the business is added as a way point. The user can stop and then continue on his or her journey without having to reprogram navigation.

In a preferred use case, a user can select the provided advertizing content 340, and directions can be provided to the selected business establishment and the location of the selected business establishment can be displayed as a way point in proximity to the route. Providing directions and displaying a way point, would be helpful to a user.

In another embodiment, queuing and displaying the provided advertizing content can be based on at least one of traffic conditions and time of day. For example, in heavy traffic congestion or during rush hour times, a user may desire to patronize and stay near the route, and would desire minimal distance off the route. Likewise, if an establishment is closed, it may not be advisable to advertise when closed.

The method can include at least one of the running step 310, detecting step 320, sensing step 330, providing step 340 and filtering step 350 being customizable by network personnel or a service provider, or by a user, to provide a unique user experience.

In one case, the sensing step 330 can include providing a location by at least one of a GPS receiver and global navigation satellite system receiver. As should be understood, other location sensing is possible such as network location methods, or inertial navigation.

In another case, a business establishment of the provided advertising content 340 can be highlighted, if a user previously selected or patronized such establishment.

In another embodiment, a wireless communication device 200 is disclosed. It can include: a housing 210 including a display; a controller 220 coupled to the housing, the controller 220 configured to control the operations of a wireless communication device; and an intelligent advertizing module 290 configured to: run a navigation application in synchronous communication with an application server; detect a direction in which a wireless communication device is traveling along a route; sense a location of a wireless communication device along the route; provide advertising content on the display, based on the detected direction of travel and sensed location of the wireless communication device in proximity to the route; and filter the advertising content based on the detected direction of travel, by preferentially highlighting business establishments on a same side of a street as the wireless communication device is traveling. Advantageously, the wireless communication device 200 is configured to help present intelligent, timely, relevant and useful advertizing content in connection with navigation and/or route planning.

In a preferred embodiment, the wireless communication device 200 can include: a housing 210 including a display; a controller 220 coupled to the housing, the controller 220 configured to control the operations of a wireless communication device; and an intelligent advertizing module 290 configured to: run a navigation application including an inputted destination; provide advertising content on a display, based on a simulated route to the destination; and filter the advertising content based on highlighting business establishments in proximity to a same side of a street as the wireless communication device will travel on. Advantageously, previewing a simulated route and previewing a listing of advertizing content including business establishments, prior to or while traveling along a route, can help a user in planning time effective trips and cost efficient and effective shopping during commutes and trips.

As shown in FIG. 4, a wireless communication device 200 can include a smart phone such as a Motorola Droid, navigation device or Zoom, for example. As should be understood, the wireless communication device 200 can be used with a holster, pouch, belt or arm strap for exercising, hiking, biking and the like.

In FIG. 4, the wireless communication device housing 210 is snap connected to the docking module 400 with fingers 410, to hold a left side securely in the docking module 400, according to one embodiment.

The device 200 and method 300 are preferably implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this disclosure.

While this disclosure has been described with specific embodiments thereof, it is evident that many alternatives, modifications, and variations will be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the disclosure by simply employing the elements of the independent claims. Accordingly, the preferred embodiments of the disclosure as set forth herein are intended to be illustrative, not limiting. Various changes may be made without departing from the spirit and scope of the disclosure.

In this document, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

We claim:

1. A wireless communication method, comprising:
running a navigation application;
detecting a direction in which a wireless communication device is traveling along a route;
sensing a location of a wireless communication device along the route;
providing advertising content, based on the detected direction of travel and sensed location of the wireless communication device in proximity to the route; and
filtering the advertising content based on the detected direction of travel, by highlighting business establishments on a same side of a street as the wireless communication device is traveling.

2. The wireless communication method of claim 1, further comprising previewing the route and providing a listing of the advertizing content prior to or while traveling along the route.

3. The wireless communication method of claim 1, further comprising queuing the advertising content based on the detected direction of travel along the route.

4. The wireless communication method of claim 1, further comprising queuing the advertising content based on the detected direction of travel and sensed location of the wireless communication device, by providing early alerts prior to reaching a maneuver point in a route.

5. The wireless communication method of claim 1, wherein the advertising content is based on at least one of fees paid by a business establishment, fees paid by a user, a predetermined distance in proximity to the route, recommendations, and interests of a user.

6. The wireless communication method of claim 1, wherein the advertising content is based on information from a social network.

7. The wireless communication method of claim 1, further comprising displaying navigation directions and advertising content concurrently on a display of the wireless communication device.

8. The wireless communication method of claim 1, further comprising presenting the advertising content based on whether a recommendation is found for a business establishment or not.

9. The wireless communication method of claim 8, wherein if a recommendation is found a first page is displayed having certain recommended advertising content.

10. The wireless communication method of claim 8, wherein if a recommendation is not found a second page is displayed having certain non-recommended advertising content.

11. The wireless communication method of claim 1, wherein the provided advertizing content includes at least one of being streamed and being presented at a predetermined periodic rate with a time out.

12. The wireless communication method of claim 1, further comprising selecting the provided advertizing content and displaying a location of a business establishment as a way point in proximity to the route.

13. The wireless communication method of claim 1, further comprising selecting the provided advertizing content, providing directions to a selected business establishment and displaying a location of the selected business establishment as a way point in proximity to the route.

14. The wireless communication method of claim 1, further comprising queuing the provided advertizing content based on at least one of traffic conditions and time of day.

15. The wireless communication method of claim 1, wherein at least one of the running step, detecting step, sensing step and providing step is customizable to provide a unique user interface experience.

16. The wireless communication method of claim 1, wherein the sensing step includes providing a location by at least one of a GPS receiver and global navigation satellite system receiver.

17. The wireless communication method of claim 1, further comprising highlighting a business establishment of the provided advertising content if previously selected.

18. A wireless communication device, comprising:
a housing including a display;
a controller coupled to the housing, the controller configured to control the operations of a wireless communication device; and
an intelligent advertizing module configured to: run a navigation application in synchronous communication with an application server; detect a direction in which a wireless communication device is traveling along a route; sense a location of a wireless communication device along the route; provide advertising content on the display, based on the detected direction of travel and sensed location of the wireless communication device in proximity to the route; and filter the advertising content based on the detected direction of travel, by highlighting business establishments on a same side of a street as the wireless communication device is traveling.

19. The wireless communication device of claim 11, wherein the intelligent advertizing module is configured to allow a user to preview a simulated route and listing of advertized content prior to or while traveling along the route.

20. A wireless communication device, comprising:
a housing including a display;
a controller coupled to the housing, the controller configured to control the operations of a wireless communication device; and
an intelligent advertizing module configured to: run a navigation application including an inputted destination; provide advertising content on the display, based on a simulated route to the destination; and filter the advertising content based on highlighting business establishments in proximity to a same side of a street as the wireless communication device will travel on.
